(19) United States
(12) Patent Application Publication
(10) Pub. No.: US 2025/0389292 A1
(43) Pub. Date: Dec. 25, 2025

(54) DRAWN DETENT OR PLUNGER APPARATUS FOR A SELF-LOCKING PIN

(71) Applicant: PIVOT POINT, INCORPORATED, HUSTISFORD, WI (US)

(72) Inventor: ROMAN J BAUS, RUBICON, WI (US)

(73) Assignee: PIVOT POINT, INCORPORATED, HUSTISFORD, WI (US)

(21) Appl. No.: 19/237,364

(22) Filed: Jun. 13, 2025

Related U.S. Application Data
(60) Provisional application No. 63/662,064, filed on Jun. 20, 2024.

(51) Int. Cl. F16B 21/12

(52) U.S. Cl. CPC F16B 21/125

(57) ABSTRACT

A detent or plunger for a self-locking pin is formed from a drawn process, a stamped process, a hydroforming process, a deep drawing process or draw forming. The detent or plunger may be formed in a single material drawn step or by a progressive tool. The detent or plunger is manufactured from thin coil or sheet stock. The portion of the detent or plunger that extends outwardly from the self- locking pin is geometrically shaped to retain the pin in an opening, while the portion of the detent or plunger disposed inside a bore formed in the pin is cylindrical. A transitional angle is formed at the point where the configuration of the detent or plunger changes from cylindrical to geometrically shaped. The transitional angle defines one or more shoulders on a side of the detent or plunger. The pin shaft is staked at one or more points along the perimeter of the bore so that the inwardly extending surface created by the staking abuts the shoulder or shoulders and prevents the detent or plunger from being removed from the bore.

### RELATED APPLICATIONS

This application claims the benefit of co-pending provisional application Ser. No. 63/662,064 filed 20 Jun. 2024.

### BACKGROUND OF THE INVENTION

### Field of Invention

The invention relates to fasteners, namely threadless fasteners and more particularly to a threadless fastener for retaining two or more structures through apertures formed in each structure.

Detent pins are well known in industry. Many of these pins fall into the category of safety bolts. Safety bolts have a threaded end to which a nut can be attached to as well as a detent mechanism along the length of the bolt. The main fastening mechanism in safety bolts is threading the nut on the end of the bolt. These products are often used in the aircraft industry so an extra safety factor is present in case vibrations cause the nut to loosen or someone forgets to tighten the nut. The detent mechanism is this extra safety factor. However, these dual fasteners make safety bolts more difficult and thus more expensive to manufacture. Additionally there are some applications where such a bolt cannot be used because it is either impractical or impossible to access the threaded end of the bolt after it is inserted through an aperture. Also, screwing the nut on the end of the bolt causes an increase in assembly time.

Cotter pins are also well known in industry. A headed pin with a cotter way is inserted through an aperture. A cotter pin is then inserted through the cotter way so the headed pin cannot be removed from the aperture. It is thus obvious that access to the backside of the workpiece is necessary for a cotter pin to be utilized. Here again, insertion of the cotter pin in the cotter way is an extra step that will take more time during assembly.

There is a need in the market for a self-locking pin including a spring loaded detent or plunger which is simple to manufacture and can be installed with little effort and in applications where there is no access to the opposing side of the workpiece and thus a nut cannot be applied to the threaded end of a pin.

### Description of Prior Art

One type of prior art bolt is disclosed in U.S. Pat. No. 4,759,671 to Duran. Duran discloses a self-retaining bolt assembly in which the detent is a solid spherically shaped ball element with cut out sections and these cut out sections must be configured to saddle protuberances in the hole to prevent rotation. The periphery of the hole is peened in order to retain the detent in the hole. The shaft and detent of this bolt must both be machined carefully to assure a proper fit and retention for the detent.

Another prior art bolt is disclosed in U.S. Pat. No. 3,561,516 to Reddy. Reddy discloses a bolt with diametrically opposed detents slidably disposed in one hole. Each detent has a lateral passage with a sloped cam surface. These sloped cam surfaces engage a cam member which retains the detents in the hole. The detents are pulled into the hole when a force is exerted on the cam surface of the cam member by the cam surfaces of the detents. The detents are moved outwardly by the biasing means disposed between the detents. A number of carefully machined parts, which are difficult to install properly, are required. Additionally, the passageway extending along the axis of the bolt weakens the bolt.

A prior art bolt is disclosed in U.S. Pat. No. 2,361,491 to Nagin. Nagin discloses a detent, generally circular in section, with a 45-degree slope at the upper end. A V-shaped groove with plane cam faces is formed in the body of the detent. The detent is slidably disposed in a hole in the shank. A circular passage extends along the bolt axis. A pin is slidably disposed in this passage. The pin is biased with a spring to engage the V-shaped groove and retain the detent in the hole. This bolt also must be carefully machined and installed to operate correctly. Additionally the passage in the shaft weakens the bolt.

A prior art self-locking pin is disclosed in U.S. Pat. No. 6,872,039 to Baus et al. Baus et al. discloses a self-locking pin having a shaft, a headed end, and detent means biased in a bore in the pin. The portion of the detent or plunger that extends outwardly from the bore is wedge-shaped, while the portion of the plunger disposed inside the bore is cylindrical. A transitional angle is formed at the point where the configuration of the plunger changes from cylindrical to wedge-shaped. The transitional angle defines shoulders on either side of the plunger. The pin shaft is staked at points along the perimeter of the bore so that the inwardly extending surface created by the staking abuts the shoulders and prevents the plunger from being removed from the bore. The plunger is manufactured from any suitable materials such as, but not limited to, alloy steels, carbon steels, stainless steel, or aluminum alloys.

### SUMMARY OF THE INVENTION

The present invention comprises a detent or plunger for a self-locking pin formed from a drawn process, a stamped process, a hydroforming process, a deep drawing process or draw forming. The detent or plunger may be formed in a single step or by a progressive tool. The detent or plunger is manufactured from thin coil or sheet stock. A variety of materials could be used in the forming process. For example, the materials include, but are not limited to stainless steel, cold or hot rolled steel, aluminum, copper, brass, bronze, galvaneal (preplated) material, and specialty alloys such as titanium, Inconel and other ferrous and non-ferrous metals.

The detent or plunger of the invention has a lower cylindrical portion and an upper wedge-shaped portion. Other embodiments have an upper chisel shaped portion, pointed portion or dome shaped portion. Other variations are possible as well. Both the upper and lower portions are integrally formed during the forming process. The lower cylindrical portion may have an open end, a closed end or a partially closed end at its bottom. The closed end or partially closed end is also integrally formed from the same material as the rest of the detent or plunger. The portion of the detent or plunger that extends outwardly from the self-locking pin is the wedge-shaped (or other shaped) portion, while the portion of the plunger disposed inside a bore formed in the pin is the cylindrical portion. A transitional angle is formed at the point where the configuration of the detent or plunger changes from cylindrical to wedge-shaped. The transitional angle defines shoulders on either side of the detent or plunger.

The drawn detent or plunger of the invention is used in a self-locking pin that provides a self-locking pin with a uniquely formed detent or plunger, which in turn facilitates easy installation of the pin through an aperture in an object or apertures in multiple objects.

The self-locking pin has an elongated shaft with a first end and a second headed end. The shaft has a hole bored in it (typically near the first end) with the drawn detent or plunger slidably disposed in the hole. The drawn detent or plunger has a lower cylindrical portion and an upper wedge-shaped (or other shaped) portion. One or more shoulders are formed on the lateral sides (or at least one side) of the drawn detent or plunger where these two portions meet. A biasing member, such as a spring, biases the drawn detent or plunger outward from the hole. The shaft of the pin is staked on lateral sides of the drawn detent or plunger with a perpendicular radius punch to retain the drawn detent or plunger in the hole. The location of the staking typically corresponds to the drawn detent or plunger's shoulders.

Once staked, the drawn detent or plunger can be depressed into the pin hole by applying a force to the top of the detent or plunger. Typically, the detent or plunger can be depressed into the hole until its uppermost portion is at or below the pin's outer surface. In its relaxed state, the detent or plunger extends outwardly from the pin's outer surface to the point where the shoulder or shoulders rest against the stake or stakes about the hole.

In an alternate embodiment, the drawn detent or plunger is formed with shoulders on its leading and trailing sides. In this embodiment, the pin shaft is staked on the leading and trailing sides of the drawn detent or plunger.

In yet another embodiment, the detent or plunger is formed with a shoulder only on its trailing side. In this embodiment, the pin shaft is staked on the trailing side of the drawn detent or plunger. The same concept could be implemented on the leading side.

In a final embodiment, the hole is bored through the entire shaft. Two drawn detents or plungers are then disposed in the through hole and each opening to the hole is staked to retain the drawn detents or plungers within the hole. A single biasing means, such as a coil spring, is located between the two detents or plungers.

The upper portion of the drawn detent or plunger can have different shapes depending upon the application. These shapes include the aforementioned wedge shape (and variations thereof), a chisel shape, a rounded shape and a pointed shape. Other variations are possible as well.

The terms “detent” and “plunger” are used interchangeably herein. These two terms are to be construed as having the same meaning. If one term is defined as broader than the other, then both terms shall be deemed to have the broader meaning.

U.S. Pat. No. 6,872,039 to Baus et al., having a common assignee, is incorporated herein by reference.

### BRIEF DESCRIPTION OF DRAWINGS

FIG. 1 is a perspective view of a pin having a drawn detent or plunger in accordance with the invention.

FIG. 2 is a top perspective view of a first embodiment of a drawn detent or plunger having an open bottom.

FIG. 3 is a bottom perspective view of a first embodiment of a drawn detent or plunger having an open bottom.

FIG. 4 is a top plan view of a first embodiment of a drawn detent or plunger having an open bottom.

FIG. 5 is a side elevation view of a first embodiment of a drawn detent or plunger having an open bottom.

FIG. 6 is a front elevation view of a first embodiment of a drawn detent or plunger having an open bottom.

FIG. 7 is a top perspective view of a first embodiment of a drawn detent or plunger having a partially open bottom.

FIG. 8 is a bottom perspective view of a first embodiment of a drawn detent or plunger having a partially open bottom.

FIG. 9 is a top plan view of a self-locking pin having a drawn detent or plunger.

FIG. 10 is a side elevation view of a pin having a drawn detent or plunger.

FIG. 11 is an end elevation view of a pin having a drawn detent or plunger.

FIG. 12A is a sectional side elevation view of a pin having a drawn detent or plunger taken through line 12-12 in FIG. 9.

FIG. 12B is a sectional side elevation view of a pin having an alternate drawn detent or plunger taken through line 12-12 in FIG. 9.

FIG. 13 is a perspective view of a pin having a drawn detent or plunger and a single stake.

FIG. 14 is a perspective view of a pin having a drawn detent or plunger and a double stake.

FIG. 15 is a top perspective view of a second embodiment of a drawn detent or plunger having an open bottom.

FIG. 16 is a bottom perspective view of a second embodiment of a drawn detent or plunger having an open bottom.

FIG. 17 is a top plan view of a second embodiment of a drawn detent or plunger having an open bottom.

FIG. 18 is a side elevation view of a second embodiment of a drawn detent or plunger having an open bottom.

FIG. 19 is a front elevation view of a second embodiment of a drawn detent or plunger having an open bottom.

FIG. 20 is a top perspective view of a second embodiment of a drawn detent or plunger having a partially open bottom.

FIG. 21 is a bottom perspective view of a second embodiment of a drawn detent or plunger having a partially open bottom.

FIG. 22 is a top perspective view of a third embodiment of a drawn detent or plunger having an open bottom.

FIG. 23 is a bottom perspective view of a third embodiment of a drawn detent or plunger having an open bottom.

FIG. 24 is a top plan view of a third embodiment of a drawn detent or plunger having an open bottom.

FIG. 25 is a side elevation view of a third embodiment of a drawn detent or plunger having an open bottom.

FIG. 26 is a front elevation view of a third embodiment of a drawn detent or plunger having an open bottom.

FIG. 27 is a top perspective view of a third embodiment of a drawn detent or plunger having a partially open bottom.

FIG. 28 is a bottom perspective view of a third embodiment of a drawn detent or plunger having a partially open bottom.

FIG. 29 is a top perspective view of a fourth embodiment of a drawn detent or plunger having an open bottom.

FIG. 30 is a bottom perspective view of a fourth embodiment of a drawn detent or plunger having an open bottom.

FIG. 31 is a top plan view of a fourth embodiment of a drawn detent or plunger having an open bottom.

FIG. 32 is a side elevation view of a fourth embodiment of a drawn detent or plunger having an open bottom.

FIG. 33 is a front elevation view of a fourth embodiment of a drawn detent or plunger having an open bottom.

FIG. 34 is a top perspective view of a fourth embodiment of a drawn detent or plunger having a partially open bottom.

FIG. 35 is a bottom perspective view of a fourth embodiment of a drawn detent or plunger having a partially open bottom.

FIG. 36 is a top perspective view of a fifth embodiment of a drawn detent or plunger having an open bottom.

FIG. 37 is a bottom perspective view of a fifth embodiment of a drawn detent or plunger having an open bottom.

FIG. 38 is a top plan view of a fifth embodiment of a drawn detent or plunger having an open bottom.

FIG. 39 is a side elevation view of a fifth embodiment of a drawn detent or plunger having an open bottom.

FIG. 40 is a front elevation view of a fifth embodiment of a drawn detent or plunger having an open bottom.

FIG. 41 is a top perspective view of a fifth embodiment of a drawn detent or plunger having a partially open bottom.

FIG. 42 is a bottom perspective view of a fifth embodiment of a drawn detent or plunger having a partially open bottom.

FIG. 43 is a top perspective view of a sixth embodiment of a drawn detent or plunger having an open bottom.

FIG. 44 is a bottom perspective view of a sixth embodiment of a drawn detent or plunger having an open bottom.

FIG. 45 is a top plan view of a sixth embodiment of a drawn detent or plunger having an open bottom.

FIG. 46 is a side elevation view of a sixth embodiment of a drawn detent or plunger having an open bottom.

FIG. 47 is a front elevation view of a sixth embodiment of a drawn detent or plunger having an open bottom.

FIG. 48 is a top perspective view of a sixth embodiment of a drawn detent or plunger having a partially open bottom.

FIG. 49 is a bottom perspective view of a sixth embodiment of a drawn detent or plunger having a partially open bottom.

FIG. 50 is a top perspective view of a seventh embodiment of a drawn detent or plunger having an open bottom.

FIG. 51 is a bottom perspective view of a seventh embodiment of a drawn detent or plunger having an open bottom.

FIG. 52 is a top plan view of a seventh embodiment of a drawn detent or plunger having an open bottom.

FIG. 53 is a front elevation view of a seventh embodiment of a drawn detent or plunger having an open bottom.

FIG. 54 is a side elevation view of a seventh embodiment of a drawn detent or plunger having an open bottom.

FIG. 55 is a top perspective view of a seventh embodiment of a drawn detent or plunger having a partially open bottom.

FIG. 56 is a bottom perspective view of a seventh embodiment of a drawn detent or plunger having a partially open bottom.

### DETAILED DESCRIPTION OF THE INVENTION

Although the disclosure hereof is detailed and exact to enable those skilled in the art to practice the invention, the physical embodiments herein disclosed merely exemplify the invention, which may be embodied in other specific structure. While the preferred embodiment has been described, the details may be changed without departing from the invention as defined by the claims.

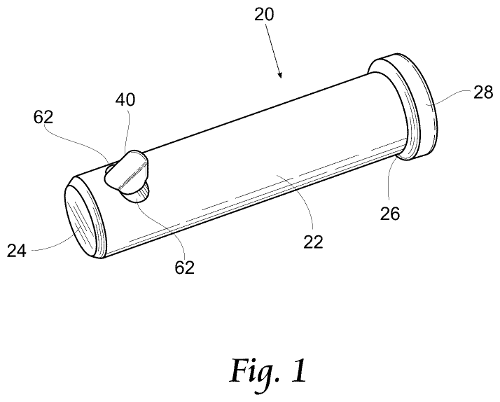

FIG. 1 illustrates a presently preferred embodiment of a self-locking pin 20, including the drawn detent or plunger 40 according to the present invention. The pin 20 has a generally cylindrical shaft 22 with a first end 24 and a second end 26. The second end 26 may have an enlarged head 28. The pin 20 may have different shaped shafts such as square, rectangular, oval, etc.

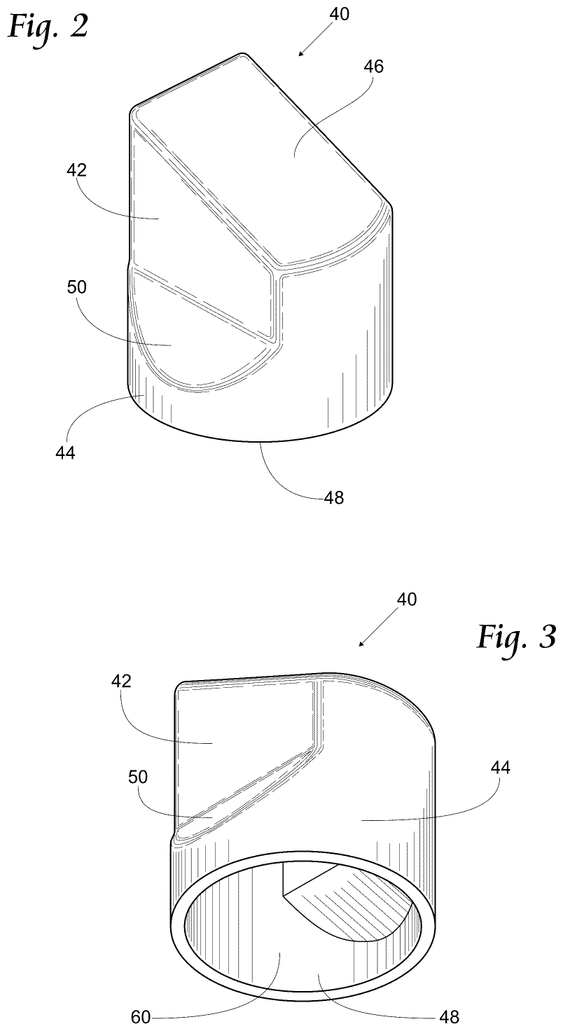

FIG. 2 is a top perspective view of a first embodiment of the detent or plunger 40. This embodiment has an upper wedge shaped portion 42 and a lower cylindrical portion 44. The upper wedge shaped portion 42 includes a ramped top surface 46. The lower cylindrical portion 44 has an open bottom 48 as best shown in the bottom perspective view of FIG. 3.

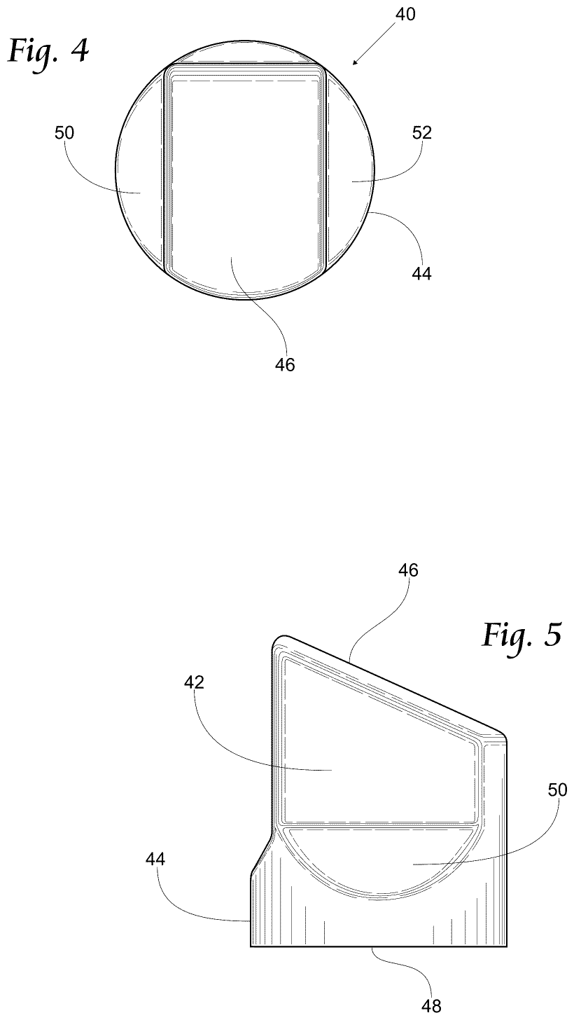

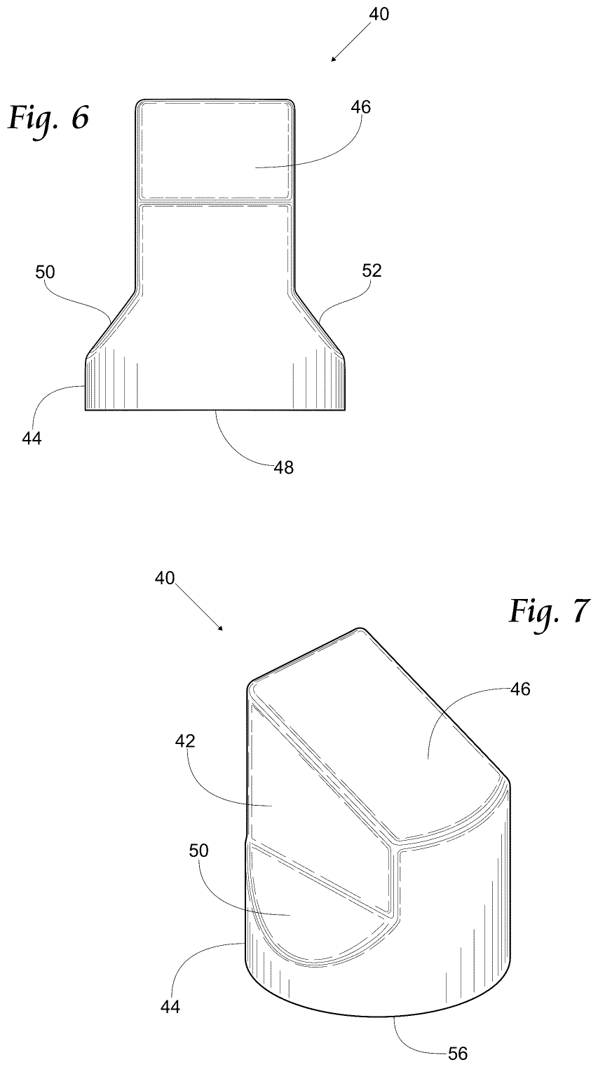

Between the upper portion 42 and lower portion 44, one or more shoulders 50, 52 are formed. These shoulders are best shown in the top view of FIG. 4, side view of FIG. 5, and front view of FIG. 6. The detent or plunger 40 has a transitional angle at the point where the configuration of the plunger 40 changes from cylindrical 44 to wedge-shaped 42. This transitional angle forms a tapered shoulder 50, 52. As will be described hereinafter, the shoulder 50, 52 helps retain the plunger 40 in the bore 30 of pin 20.

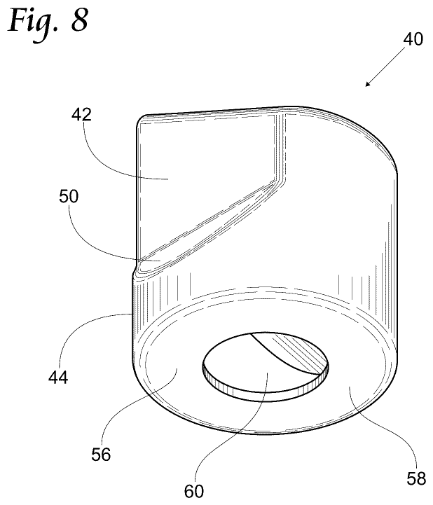

FIG. 7 is a perspective view similar to FIG. 2, except the cylindrical portion 44 is partially closed on its bottom surface 58. The partially closed bottom 56 is best shown in FIG. 8. With an open bottom 48 or partially closed bottom 56, the interior 60 of the detent or plunger can be seen as also shown in FIG. 8. While not shown, it should be appreciated that the entire bottom surface of the cylindrical portion can be fully closed.

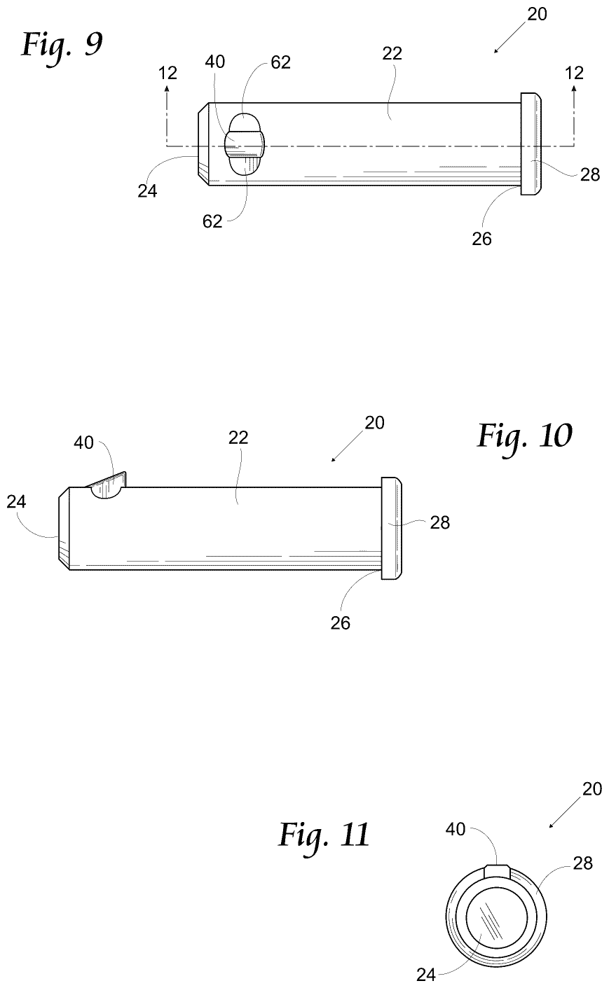

FIGS. 9, 10, and 11 show views of the pin 20 from the top, side, and end respectively. As best shown in the top view of FIG. 9, the detent or plunger 40 is retained in the pin 20 by a staking process. In the self-locking pin embodiment depicted in FIG. 9, the stakes 62 are applied relative to the shoulders 50 of the detent or plunger 40. FIGS. 10 and 11 show the detent or plunger 40 in its fully extended position relative to the shaft 22 of the pin 20. The height of the fully extended detent or plunger 40 can be substantially equal to, less than or greater than the outer diameter of the enlarged head 28 (see FIG. 11).

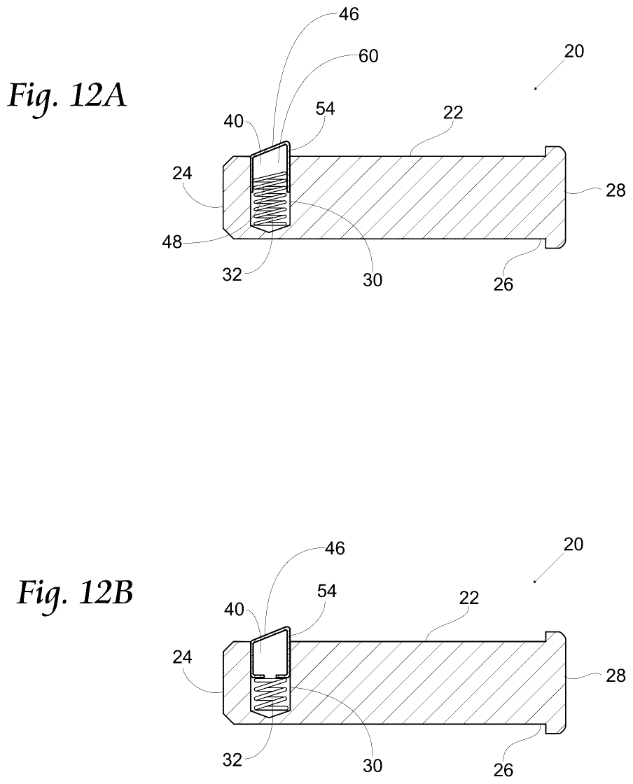

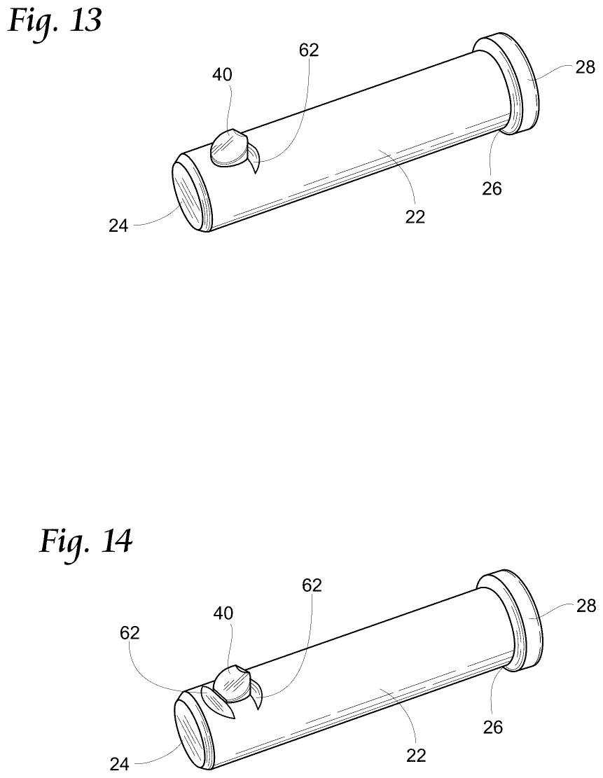

As shown in FIGS. 12A and 12B, a re-entrant bore 30 extends partway through the shaft 22 near the first end 24. The bore 30 extends radially inwardly towards the axis of the shaft. The bore 30 may or may not intersect the central longitudinal axis of the shaft. A biasing means, such as a coil spring 32, is placed in the bore 30. The detent or plunger 40 is placed in the bore on top of the coil spring 32 and is slidably disposed in the bore 30. As shown in FIG. 12A and for a detent or plunger 40 having an open bottom 48, the end of the helical coil spring 32 enters the open end 48 of the detent or plunger 40 and resides in its interior 60. As shown in FIG. 12B and for a detent or plunger 40 having a closed or partially closed bottom 56, the detent or plunger 40 bottom surface 58 sits upon the end of the helical coil spring 32. It should be appreciated that the coil spring 32 could be replaced with a leaf spring, a compressible material, an elastic material or other suitable biasing means.

Still referring to FIGS. 12A and 12B, when the detent or plunger 40 is in its normal position in the bore 30, the cylindrical portion 44 resides substantially below the surface of the shaft 22 and the wedge-shaped portion 42 extends substantially above the surface of the shaft 22. The top surface of the plunger 40 extends angularly upwardly away from the surface of the shaft 22 to define the ramped engaging surface 46 and the abutment 54. The abutment 54 is perpendicular or normal to the axis of the shaft 22 and faces the direction of the second end 26.

The detent or plunger 40 may be manufactured from thin coil or sheet stock. A variety of materials can be used in the forming process. For example, the materials may include, but are not limited to stainless steel, cold or hot rolled steel, aluminum, copper, brass, bronze, galvaneal (preplated) material, and specialty alloys such as titanium, Inconel and other ferrous and non-ferrous metals. The shaft 22 may be fabricated or formed from any suitable materials such as, but not limited to, alloy steels, carbon steels, stainless steel, or aluminum alloys.

To assemble the self-locking pin 20, the biasing member (spring) 32 is first placed in the re-entrant bore 30. Next, the detent or plunger 40 is placed in the bore 30 in the correct orientation. The pin 20 is held in place, with the plunger 40 in its depressed position, by one tool while another tool punches the shaft 22 using a radius stake punch (or the like) perpendicular to the pin 20.

The typical staking locations are shown in FIG. 9. Alternate staking locations are shown in FIGS. 13 and 14. A single or multiple stakes may be formed about the periphery of the bore 30 at the surface of the pin 20. As shown in FIG. 13, a single stake may be placed behind the detent or plunger 40. In FIG. 14, two stakes 62 are utilized but are placed on leading and trailing sides of the bore 30. Each stake 62 causes a change in the shape of the shaft 22 around the entrance to the bore 30. The smooth round bore 30 is formed by the staking process to a substantially oval shape with some depth. In the preferred embodiment of FIG. 9, the shaft 22 is staked on the lateral sides of the detent or plunger 40. The staking 62 forms inwardly extending marginal portions. These inwardly extending marginal portions abut the shoulders 50, 52 of the plunger 40 as the spring 32 urges the plunger 40 outwardly of the bore 30. The edge or edges of the staking 62 prevents the plunger 32 from rotating or being removed from the bore 30.

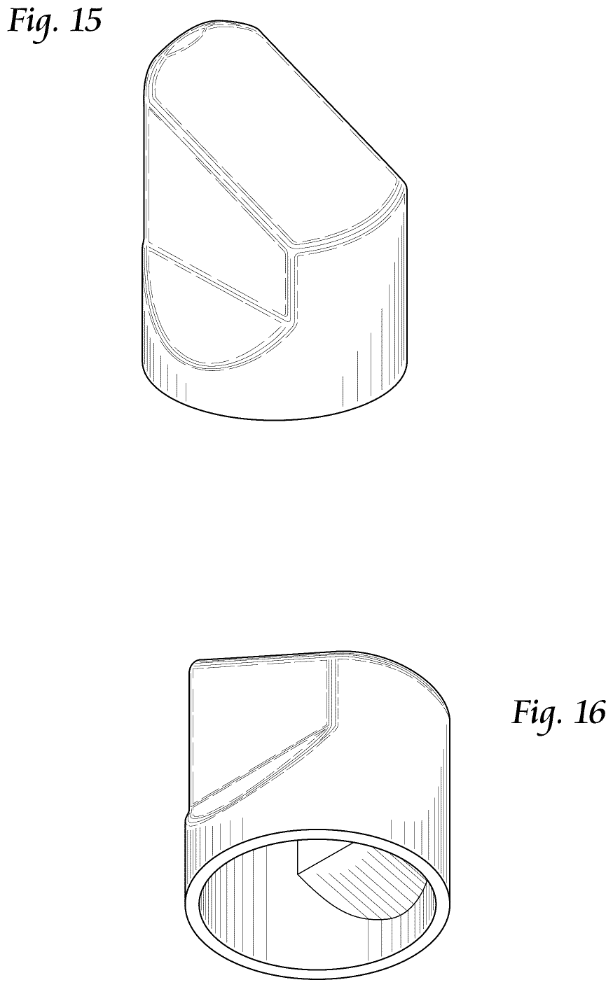

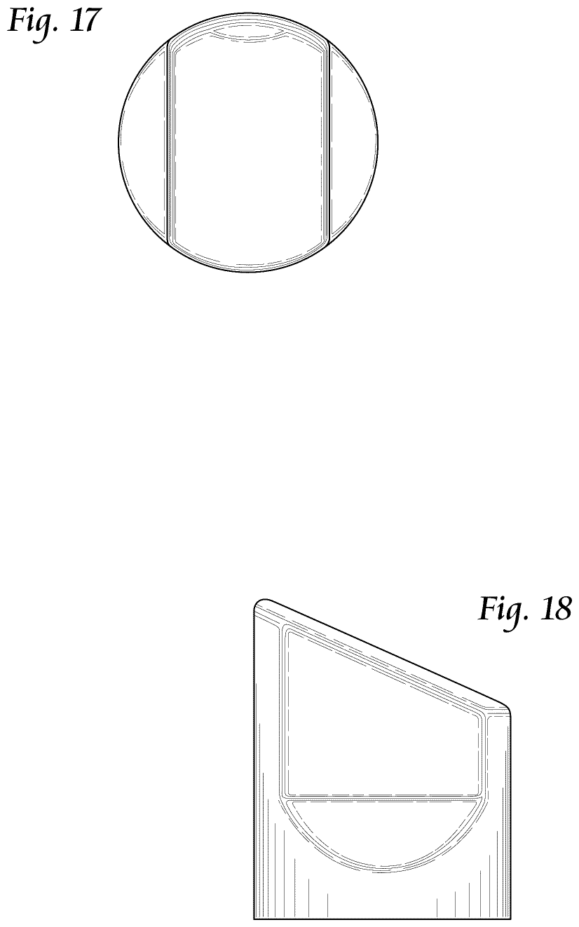

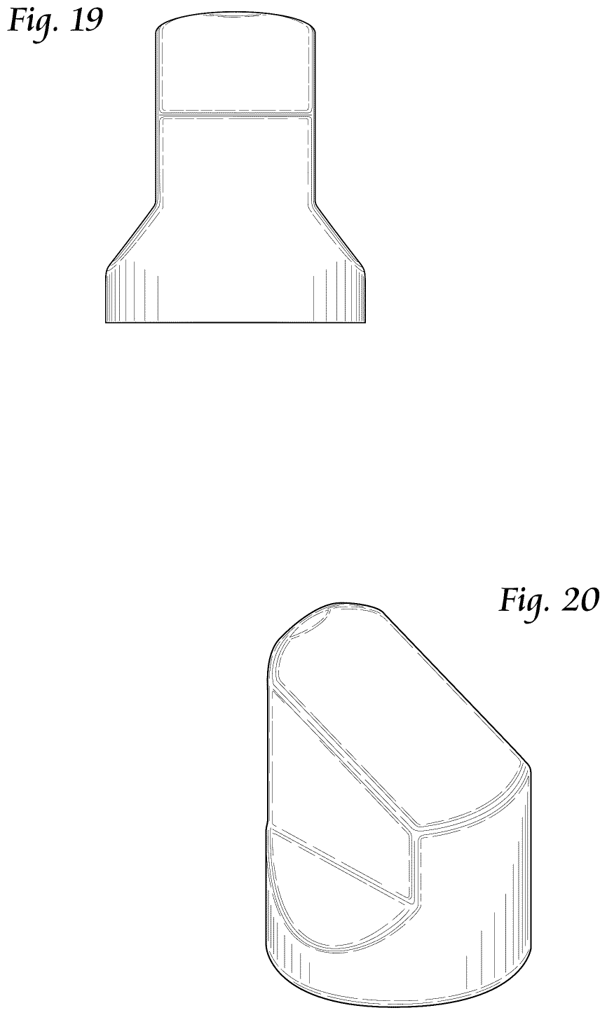

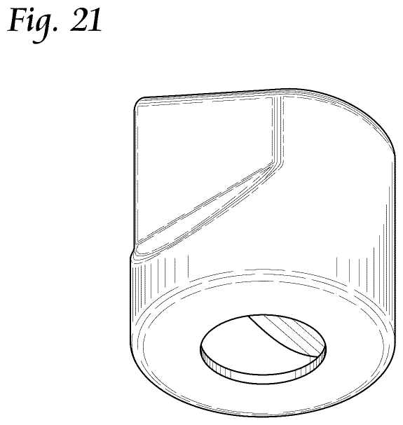

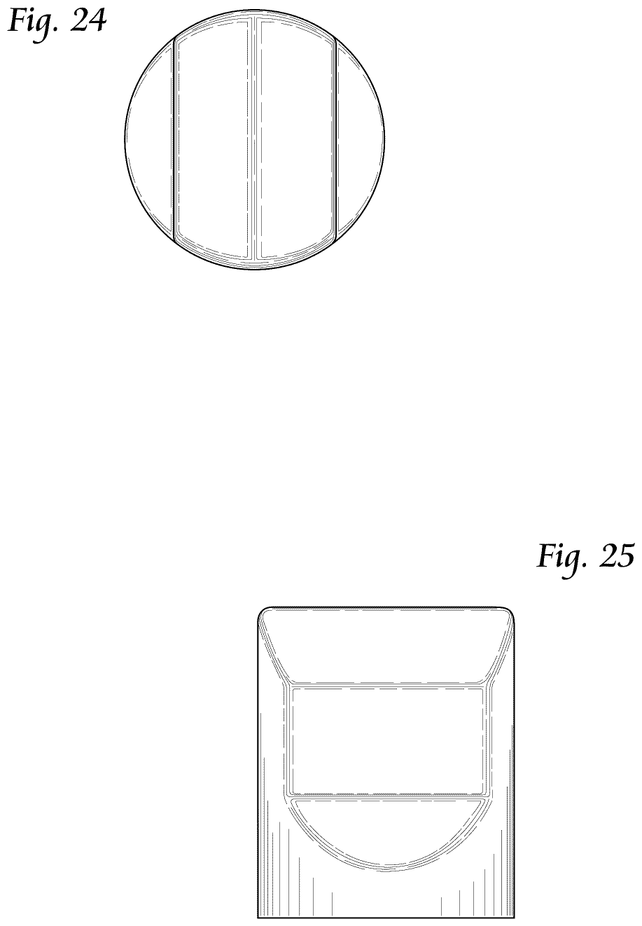

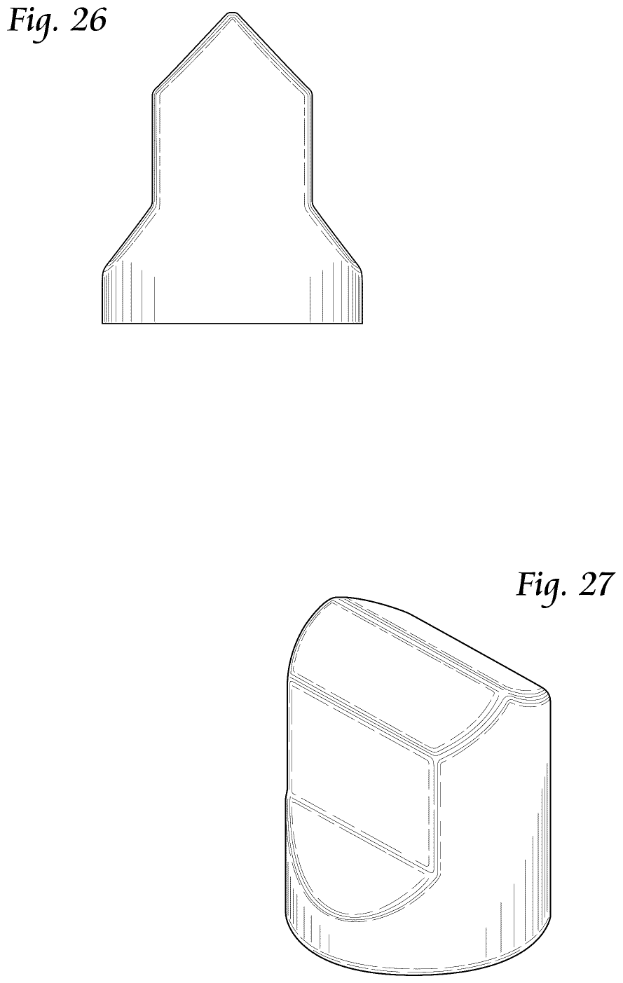

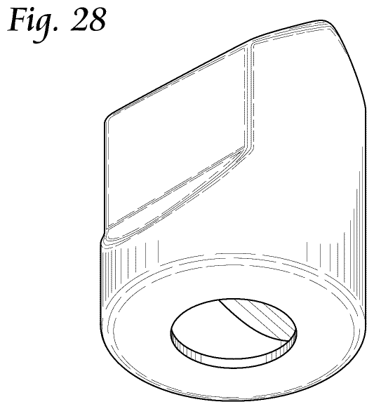

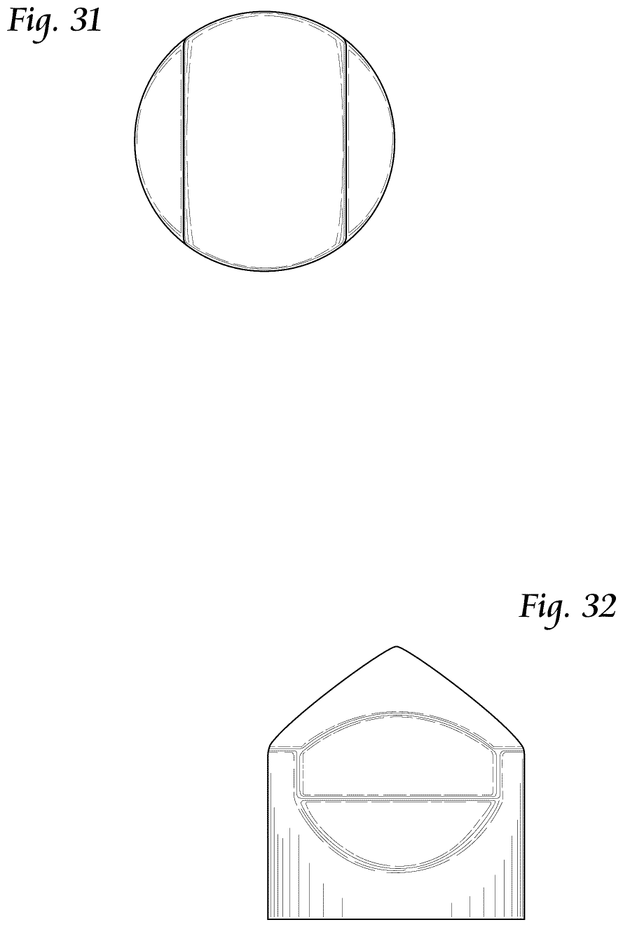

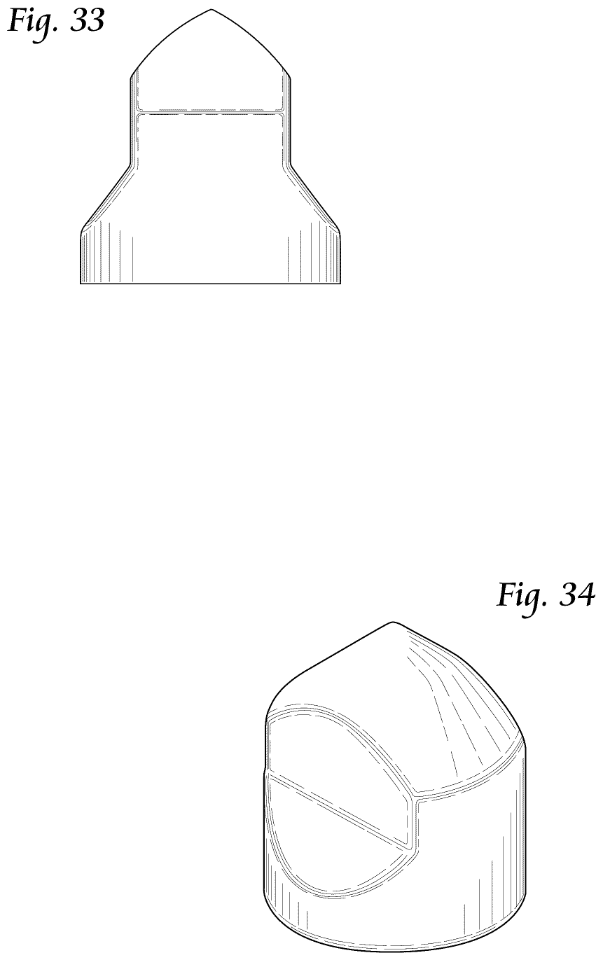

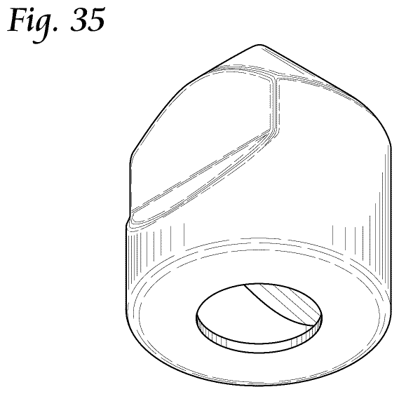

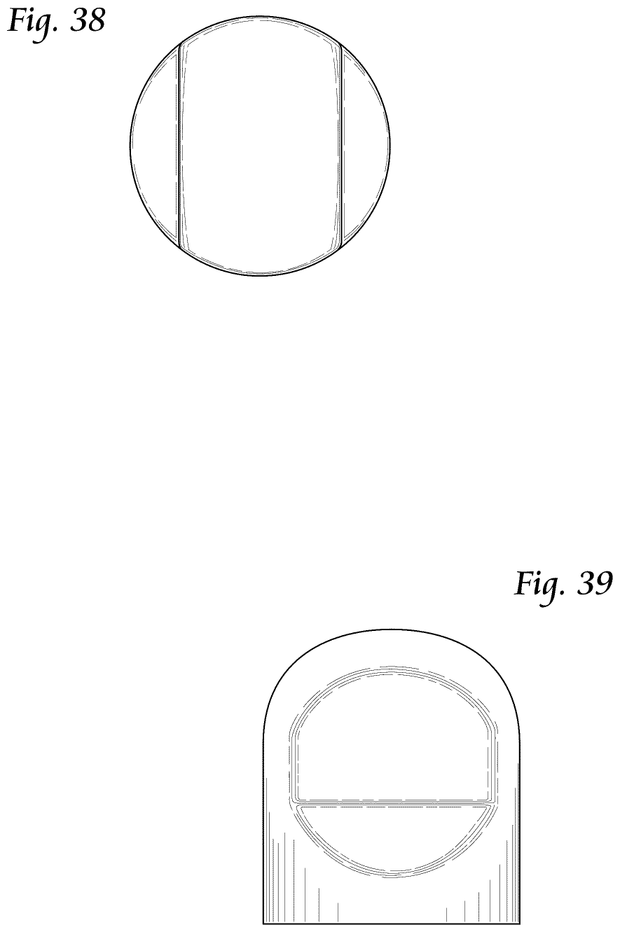

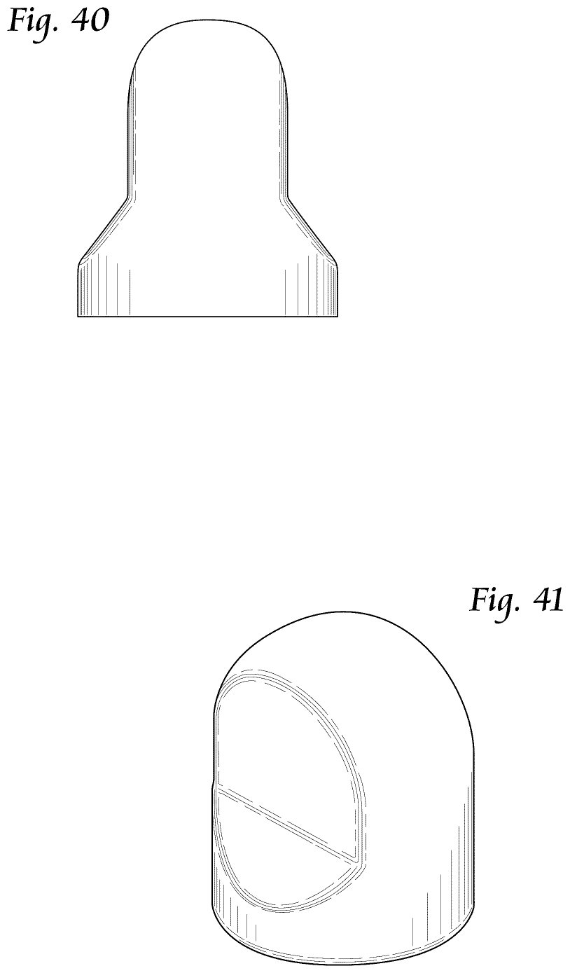

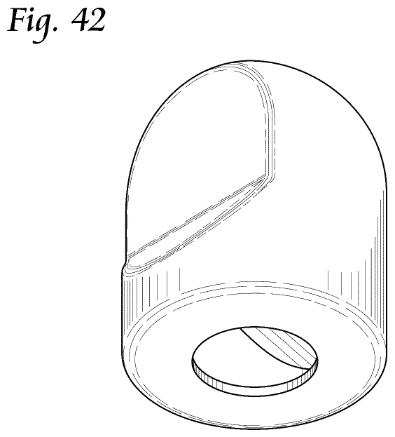

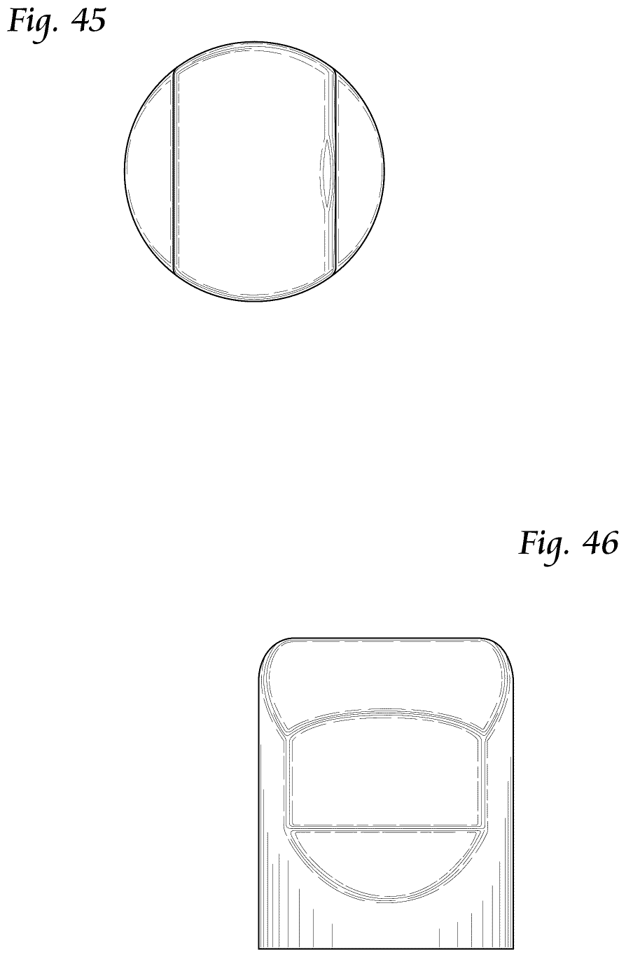

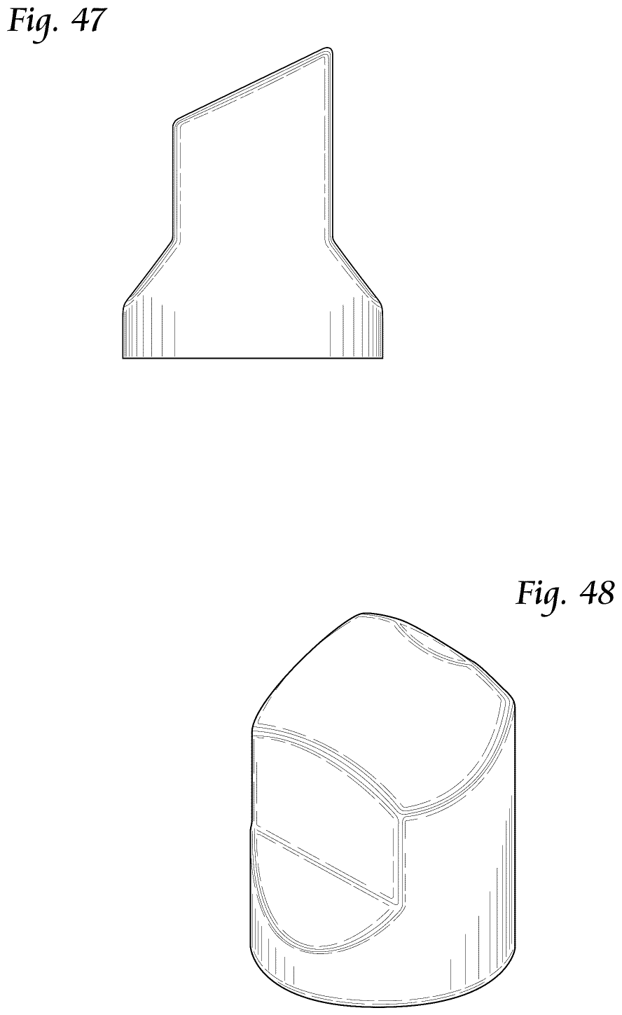

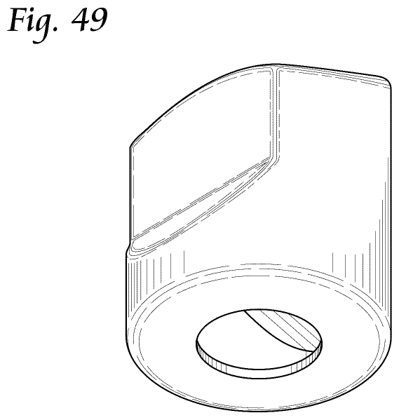

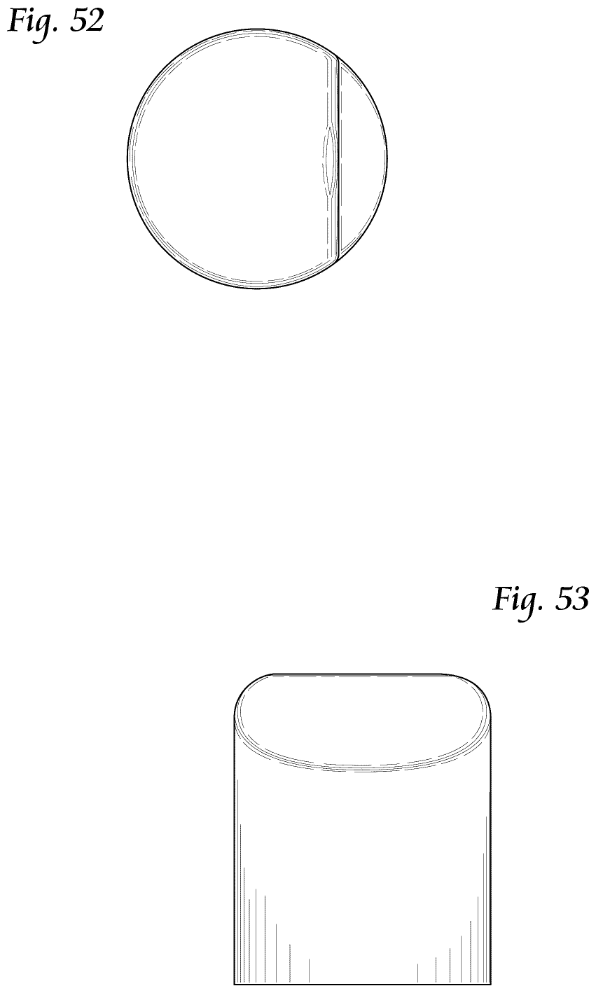

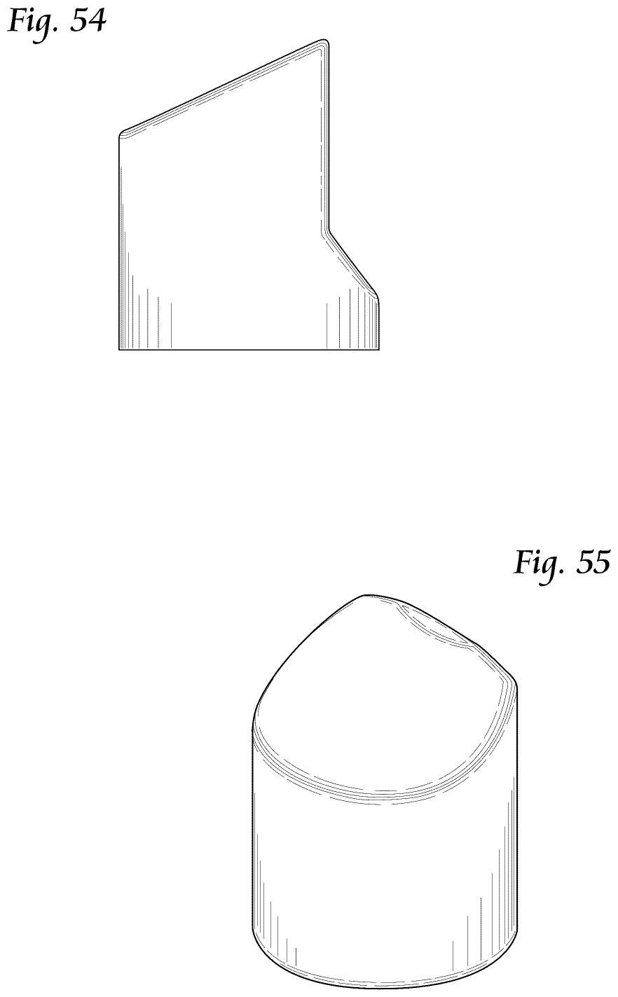

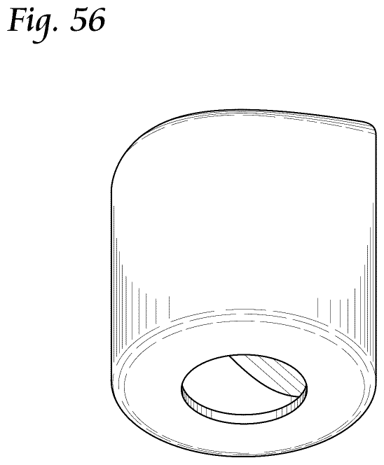

FIGS. 15-56 show alternate embodiments of the detent or plunger 40. The embodiment of FIGS. 15-21 is very similar to the embodiment of FIGS. 2-9 with the exception that the cylindrical shape of the lower portion continues through the uppermost part of the ramped top surface.

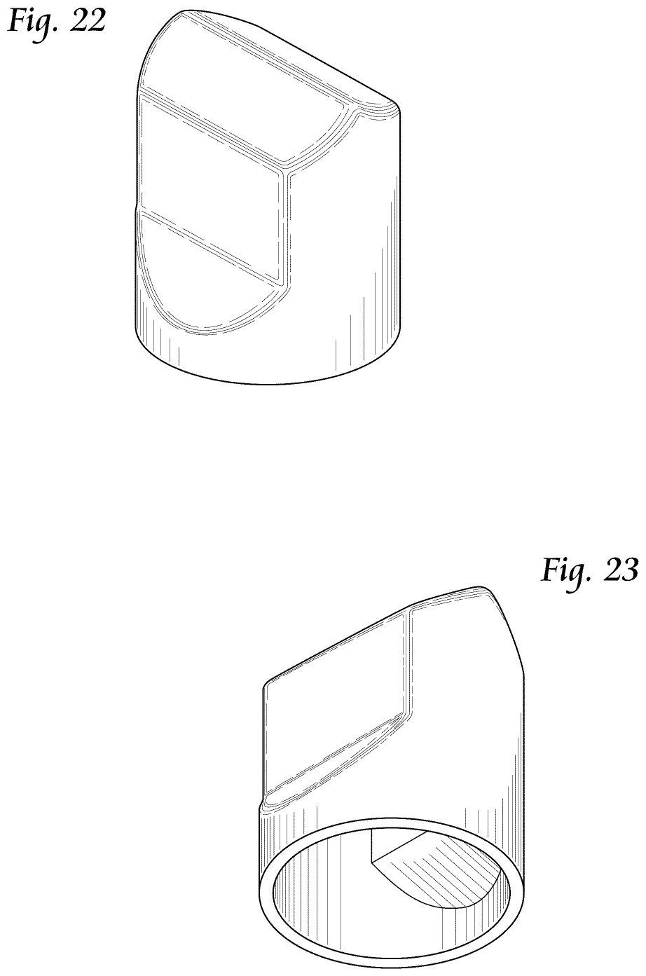

The embodiment of FIGS. 22-28 has a chisel shaped upper portion.

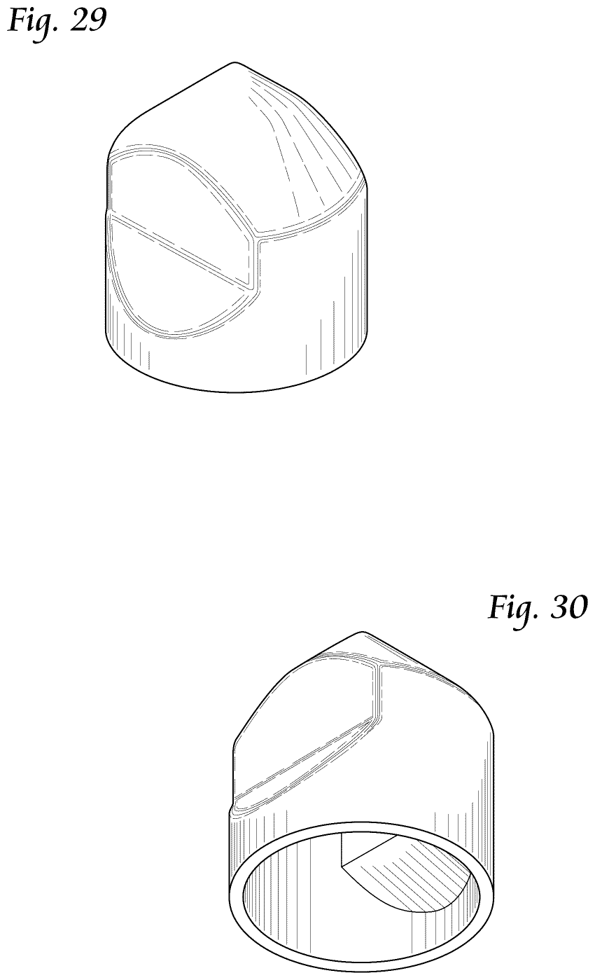

The embodiment of FIGS. 29-35 has a pointed upper portion.

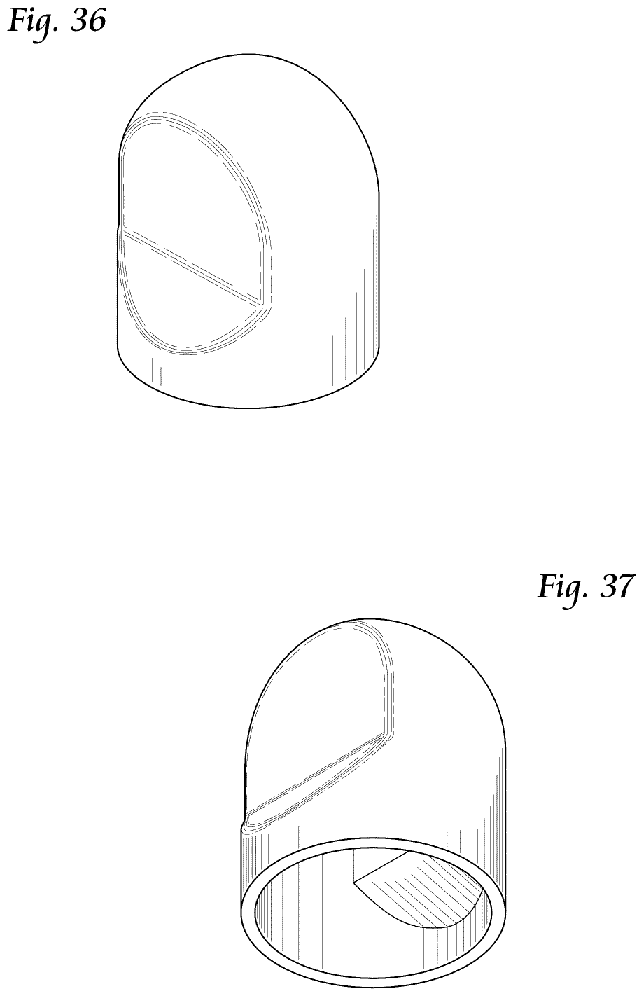

The embodiment of FIGS. 36-42 has a rounded upper portion.

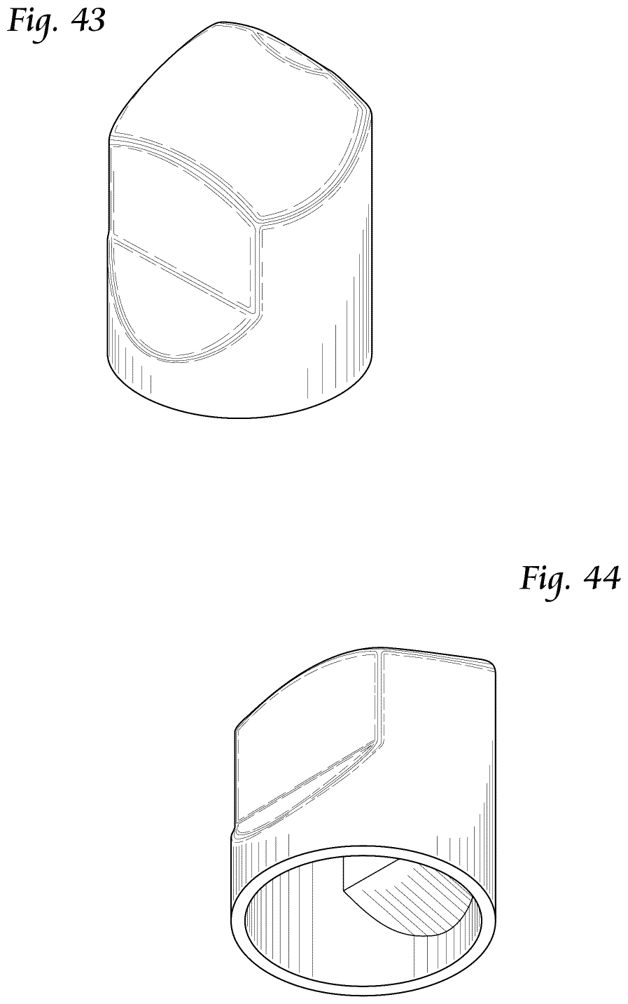

The embodiment of FIGS. 43-49 has a wedge-shaped upper portion, but with the shoulders at a different location. The shoulders are positioned ninety degrees offset than the shoulders in the prior embodiments. This embodiment may be retained in the bore 30 with a double leading and trailing edge staking operation as shown in FIG. 14.

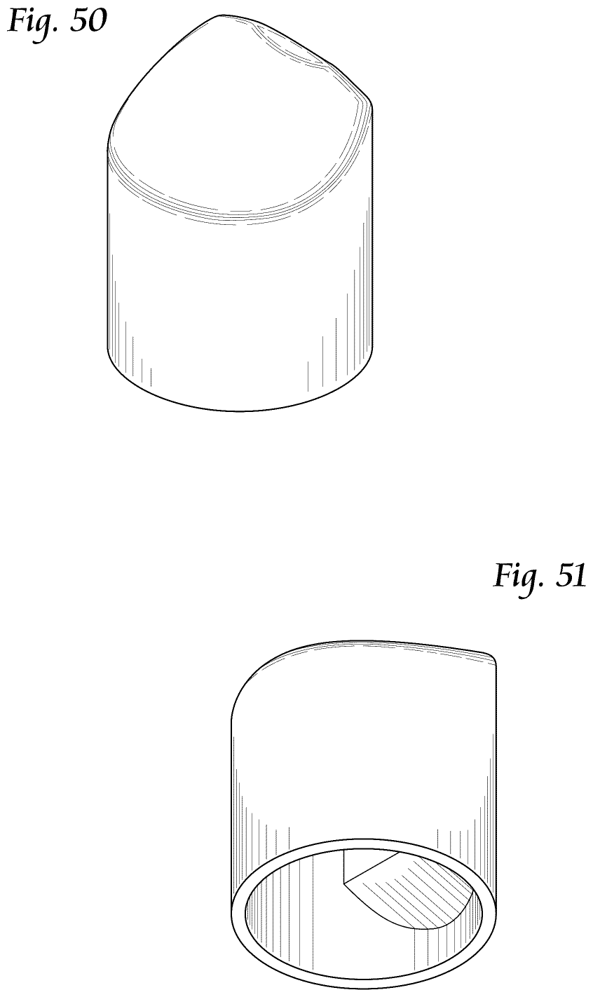

The embodiment of FIGS. 50-56 has a wedge-shaped upper portion, but with a single shoulder beneath the highest location of the ramped surface. This embodiment may be retained in the bore 30 with a single staking operation as shown in FIG. 13.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention as defined by the claims.

1. A metal plunger for a self-locking pin, the plunger comprising:
a first portion and a second portion;
the first portion having a cylindrical shape;
the second portion having a geometrical shape;
the first portion and second portion being integral with one another;
a transition angle formed between the first portion and the second portion
at least one shoulder formed at the transition angle; and
the plunger being formed from a sheet-like material

2. The plunger of claim 1 wherein the second portion geometrical shape is wedge shaped.

3. The plunger of claim 1 wherein the second portion geometrical shape is chisel shaped.

4. The plunger of claim 1 wherein the second portion geometrical shape is pointed shaped.

5. The plunger of claim 1 wherein the second portion geometrical shape is rounded shaped.

6. The plunger of claim 1 wherein the first portion has an open bottom.

7. The plunger of claim 1 wherein the first portion has a partially open bottom.

8. The plunger of claim 1 wherein two shoulders are formed at the transition angle.

9. The plunger of claim 1 wherein the sheet like material is selected from the group consisting of stainless steel, cold rolled steel, hot rolled steel, aluminum, brass, bronze, galvanneal and titanium.

10. A metal detent for a self-locking pin, the pin having a longitudinal axis, an elongated shaft parallel with said axis, a first end, a second end, a bore formed between the first end and second end perpendicular to said longitudinal axis and a biasing member located in the bore, the detent comprising:
a first portion and a second portion unitarily formed from a sheet material;
the first portion having a cylindrical
the second portion having a geometrical shape
a transitional angle formed between the first portion and the second portion;
whereby the detent can be placed in the bore and a stake can be applied about a portion of the periphery of the bore of the pin to retain the detent in the bore.

11. The detent of claim 10 wherein the second portion geometrical shape is wedge shaped.

12. The detent of claim 10 wherein the second portion geometrical shape is chisel shaped.

13. The detent of claim 10 wherein the second portion geometrical shape is pointed shaped.

14. The detent of claim 10 wherein the second portion geometrical shape is rounded shaped.

15. The detent of claim 101 wherein the first portion has an open bottom.

16. The detent of claim 10 wherein the first portion has a partially open bottom.

17. The detent of claim 10 wherein at least one shoulder is formed at the transition angle.

18. The detent of claim 10 wherein the sheet material is selected from the group consisting of stainless steel, cold rolled steel, hot rolled steel, aluminum, brass, bronze, galvanneal and titanium.
